(19) United States
(12) Patent Application Publication
(10) Pub. No.: US 2017/0215350 A1
(43) Pub. Date: Aug. 3, 2017

(54) OPEN PLANT CULTIVATION DEVICE AND METHOD FOR PREPARING THE SAME

(71) Applicant: Orchid Gene, LLC., Morrisville, NC (US)

(72) Inventors: Hsi-Chuan Chen, Morrisville, NC (US); Chih-Feng Hsu, New Taipei City (TW)

(21) Appl. No.: 15/284,911

(22) Filed: Oct. 4, 2016

Related U.S. Application Data
(60) Provisional application No. 62/290,443, filed on Feb. 2, 2016.

(51) Int. Cl. A01G 9/10; A01G 31/00; A01G 1/00

(52) U.S. Cl. CPC A01G 9/1033; A01G 1/001; A01G 9/1086; A01G 31/001

(57) ABSTRACT

An open plant cultivation device has a container, a medium layer, a plant, and a separation layer. The container has an inner side surface, a sterile accommodation space, and an open growing space. The medium layer is disposed in the sterile accommodation space. The separation layer is disposed on the medium layer and adjacent to the inner side surface. The sterile accommodation space and the open growing space are isolated by the separation layer. A method for preparing an open plant cultivation device includes: putting a container in a sterile space; feeding a medium colloid into the container and immersing a part of a plant in the medium colloid; solidifying the medium into a medium layer; disposing a separation layer onto the medium layer to form the open plant cultivation device. The present invention has the open growing space and the effect of protecting the medium layer from contamination.

### CROSS-REFERENCE TO RELATED APPLICATION

Pursuant to 35 U.S.C. §119(e), this application claims the benefit of the priority to U.S. Provisional Patent Application No. 62/290,443, filed Feb. 2, 2016. The content of the prior application is incorporated herein by its entirety.

### BACKGROUND OF INVENTION

### 1. Field of the Invention

The present invention relates to culture technology, and particularly relates to an open plant cultivation device and a method for preparing the open plant cultivation device.

### 2. Description of the Related Art

Plants have the functions of air purification, environmental greenification, and oxygen production. People today often cultivate plants indoors. To sustain living of the plants, appropriate illumination and sufficient supply of water and nutrients should be provided.

However, different species of plants need different living environments. Take orchidaceae for example, orchidaceae are a diverse and widespread family of flowering plants that are popular and often used as indoor decorations. Due to the specific living environment of orchidaceae, dedicated attention is needed to look after orchidaceae, so bottle flowers are developed for commercial use in the market to overcome the inconveniences.

The bottle flower as provided usually seals medium, including nutrients and water, in the flask to allow plants to grow and bloom up. Nevertheless, medium can also be utilized by other microorganisms, such as bacteria or fungi. In order to prevent the plants from getting infected by bacteria or fungi, the plants can only be cultivated in a sterile environment to grow smoothly.

Generally, the bottle flower is sealed after sterilization to allow the plants to grow in a sterile living environment. With reference to FIG. 3, a closed plant cultivation device 90 includes a flask 91, a medium 92, a plant 93, and a plug 94. The flask 91 contains an accommodation space 911 and a closed growing space 912. The accommodation space 911 communicates with the closed growing space 912. After the sterilization of the apparatus and contents, the medium 92 is fed into the accommodation space 911 of the flask 91. A part of the plant 93 is immersed in the medium 92 and the remaining part of the plant 93 is disposed in the closed growing space 912. The plug 94 is used to seal the flask 91 to compose the closed plant cultivation device 90.

However, the closed plant cultivation device has disadvantages as follows.

First, due to the airtight flask, the concentration of carbon dioxide or ethylene may increase after a long-term low illumination condition or after a long-term cultivation.

Second, the temperature difference between the interior and the exterior of the closed plant cultivation device may form mist. If mist cannot disperse away from the closed plant cultivation device, it will reduce the light transmittance of the flask, obstruct the observation, and hinder the photosynthetic capacity of the plant.

Third, when water vapor accumulates in the closed plant cultivation device and makes the relative humidity reach 70% to 100%, the humid environment may make the plant have a thinner cuticle, have an underdeveloped stoma, or incur hyperhydricity. The morphogenesis change of the plant may reduce the transplantation survival rate and need acclimation after transplantation.

Forth, the closed plant cultivation device may decrease the joy of cultivating the plant indoors. People have to view the plant via the flask and hence cannot touch or smell the plant. Besides, the plant is hard to purify the air or produce oxygen out of the closed plant cultivation device.

### SUMMARY OF THE INVENTION

The objective of the present invention is to provide an open plant cultivation device which has an open growing space to solve the problems of the closed plant cultivation device.

In order to achieve the aforementioned objective, the present invention provides an open plant cultivation device comprising a container, a medium layer, a plant, and a separation layer. The container has an inner side surface, a sterile accommodation space, and an open growing space; the sterile accommodation space and the open growing space are both surrounded by the inner side surface. The medium layer is disposed in the sterile accommodation space of the container. The plant is disposed in the sterile accommodation space of the container and disposed in the open growing space of the container. A part of the plant is immersed in the medium layer. The separation layer is disposed on the medium layer; the separation layer is adjacent to the inner side surface. The sterile accommodation space and the open growing space are isolated from each other by the separation layer.

By the aforementioned invention of the open plant cultivation device, the medium layer provides the plant with nutrients. The cultivator does not need to fertilize and cultivate the plant. The plant can be transplanted without acclimation after fully absorbing the medium layer and will not have any underdeveloped cuticle and stoma. Besides, the separation layer prevents the medium layer from contamination by the exterior environment to protect the plant from infection. Also, the installation of the separation layer can replace the plug in the closed plant cultivation device. Therefore, the plant will not live in an inadequate environment of high concentration of carbon dioxide or ethylene, low transmittance, low illumination, and high humidity. Further, the open plant cultivation device can sustain the interest and joy of cultivating plants indoors. The cultivator can view, touch, or smell the plant directly and the plant can purify the air and produce oxygen to outside of the container.

In addition, owing to the open growing space, the cultivator can put the open plant cultivation device in an environment under controlled temperature and controlled humidity in order to provide a better living environment for the plant.

Preferably, a curing temperature of a material of the separation layer is from 20° C. to 70° C. Adopting the separation layer with lower curing temperature is convenient for operation, which can be melted to be flowable at lower temperature, and would not harm the plants by high temperature condition when the separation layer is placed onto the medium layer. Also, when the material of the separation layer has flowability at room temperature, the separation layer will cause less negative influences on growth of the plant.

Preferably, a thickness of the separation layer is from 0.05 cm to 5 cm.

Preferably, the material of the separation layer is natural wax, synthetic wax, lipid compound, polyester, polyepoxide, or silicone-containing compound. The separation layer is formed in a solid, colloidal, or liquid state. When the separation layer is made of lipid compound, the separation layer may be formed in a liquid state at room temperature. When the material of the separation layer is natural wax or synthetic wax, the separation layer may be formed in a solid or liquid state at room temperature according to its curing temperature. When the material of the separation layer is polyester or polyepoxide, the separation layer may be formed in a solid, elastic colloidal or liquid state at room temperature according to its specific content and/or property. When the material of the separation layer is silicone-containing compound, the separation layer may be formed in a solid, elastic colloidal or liquid state at room temperature according to the specific content and/or the property of the silicone-containing compound. Besides, the silicone-containing compound can be cured alternatively. The silicone-containing compound can be cured by, but not limited to, temperature, ultraviolet, or a curing agent.

Preferably, the medium layer includes water, an inorganic salt, an organic compound, a plant growth regulator, agar, or an active carbon. In addition, the water includes coconut water; the elements of the inorganic salt include carbon, hydrogen, oxygen, nitrogen, phosphorus, potassium, sodium, magnesium, calcium, sulfur, chlorine, ferric, boron, manganese, zinc, molybdenum, cobalt, copper, or iodine; the organic compound includes carbohydrate, vitamin, inositol, adenine, or amino acid.

The method for preparing the open plant cultivation device is conducted by the steps of: putting a container in a sterile space; feeding a medium colloid into the container and immersing a part of a plant in the medium colloid; solidifying the medium colloid into a medium layer; and disposing a separation layer onto the medium layer to form the open plant cultivation device.

According to the method for preparing the open plant cultivation device, the medium colloid is fed into the container before the plant is immersed in the medium colloid. Or, the plant is disposed in the container before the medium colloid is fed into the container and the part of the plant is immersed in the medium colloid.

### BRIEF DESCRIPTION OF THE DRAWINGS

FIG. 1 is a perspective view of an open plant cultivation device of the present invention;

FIG. 2 is a flow diagram of a method for preparing the open plant cultivation device of the present invention;

FIG. 3 is a side view of a closed plant cultivation device of the prior art.

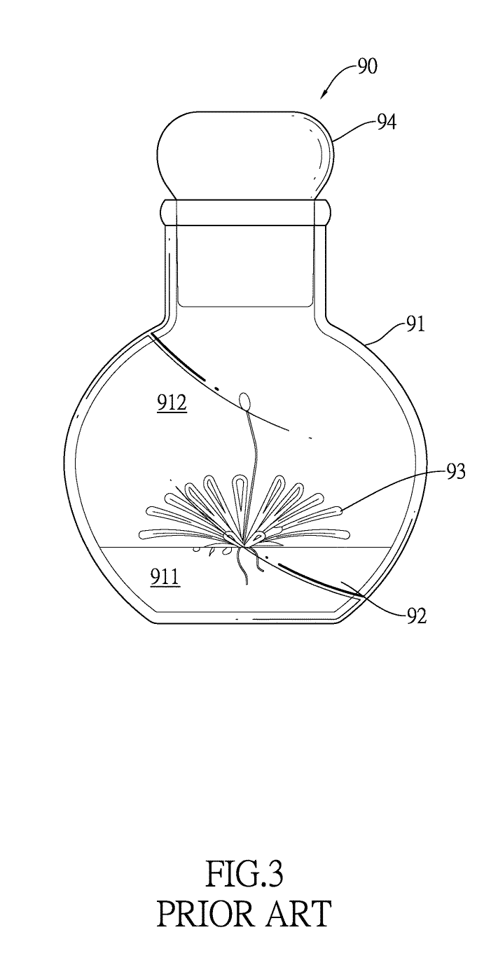

### DETAILED DESCRIPTION OF INVENTION

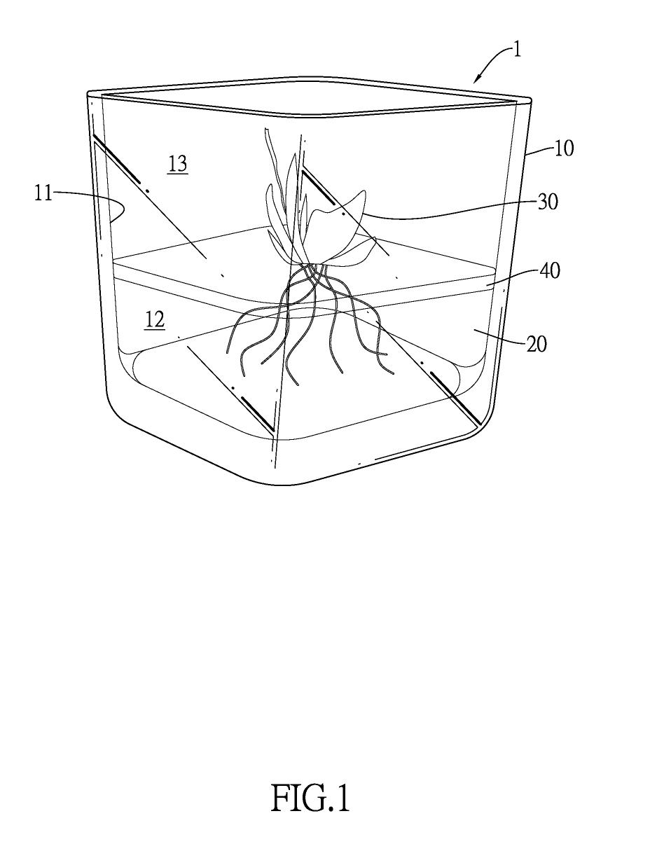

With reference to FIG. 1, an open plant cultivation device 1 includes a container 10, a medium layer 20, a plant 30, and a separation layer 40.

The container 10 has an opening, a bottom surface, an inner side surface 11, a sterile accommodation space 12, and an open growing space 13. The inner side surface 11 is formed from the periphery of the bottom surface. The sterile accommodation space 12 is defined by the bottom surface and the inner side surface 11. The open growing space 13 is defined by the inner side surface 11, and is adjacent to the sterile accommodation space 12 and communicates with the opening of the container 10.

The medium layer 20 is disposed in the sterile accommodation space 12 of the container 10. The medium layer 20 has an upper surface opposite the bottom surface of the container 10.

The plant 30 is disposed in the sterile accommodation space 12 of the container 10 and disposed in the open growing space 13 of the container 10. A part of the plant 30 is immersed in the medium layer 20.

The separation layer 40 is disposed in the sterile accommodation space 12 of the container 10 and disposed on the upper surface of the medium layer 20. The separation layer 40 is adjacent to the inner side surface 11 of the container 10. The sterile accommodation space 12 and the open growing space 13 are isolated from each other by the separation layer 40. That is, the medium layer 20 is surrounded by the container 10 and the separation layer 40 to separate the medium layer 20 from the exterior and to prevent the medium layer 20 from being contaminated.

Specifically, the material of the container 10 is endurable for sterilization. A material of the medium layer 20 is adjustable according to the species of the plant 30. A material of the separation layer 40 has a low curing temperature (lower than 70° C.).

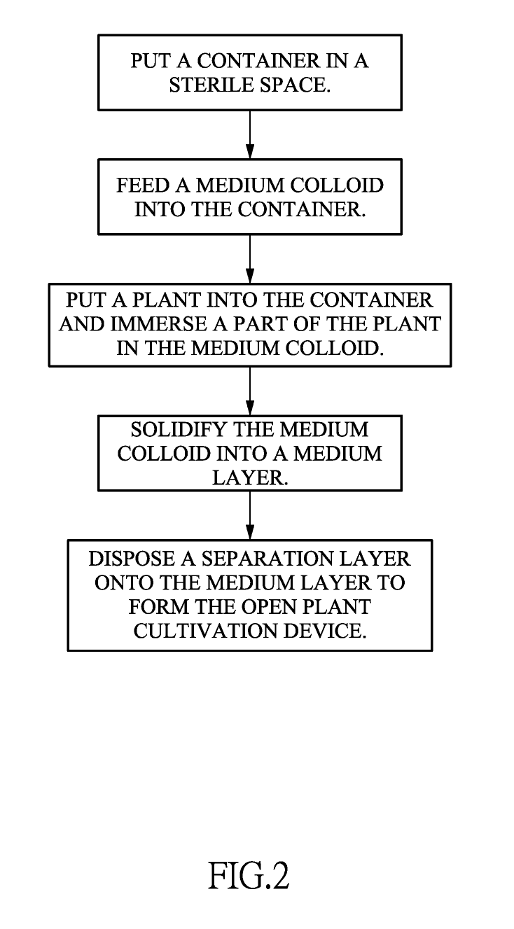

With reference to FIGS. 1 and 2, the method for preparing the open plant cultivation device 1 was conducted by the steps as follows. First, the container 10 was put in a sterile environment. At this step, the sterile accommodation space 12 and the open growing space 13 communicated with each other before the medium layer 20, the plant 30, and the separation layer 40 were disposed in the container 10.

Then a medium colloid was prepared by a conventional adequate method according to the species of the plant 30, and then adequate amount of the medium colloid was fed into the sterile accommodation space 12 of the container 10.

In particular, the material of the medium layer 20 was composed of water, an inorganic salt, and an organic compound. Specifically, the major elements of the inorganic salt included carbon, hydrogen, oxygen, nitrogen, phosphate, potassium, sodium, magnesium, calcium, sulfur, chlorine, and ferric; the minor elements of the inorganic salt included boron, manganese, zinc, molybdenum, cobalt, copper, and iodine. The organic compound included hydrocarbon, vitamin, inositol, adenine, amino acid, a plant growth regulator, and agar.

Subsequently, the plant 30 was disposed in the container 10, and then a part of the plant 30 was immersed in the medium colloid.

In another embodiment, the plant 30 was disposed in the container 10 after the container 10 was put in the sterile environment. Then, the medium colloid was fed into the sterile accommodation space 12 of the container 10 and the part of the plant 30 was immersed in the medium colloid.

Then the medium colloid was solidified into the medium layer 20.

Finally, a layer of jelly wax (curing temperature: 60° C., with flowability at room temperature) was disposed on the medium layer 20. The layer of jelly wax acted as the separation layer 40. The thickness of the separation layer 40 was 0.5 cm.

By means of the installation of the separation layer 40, the sterile accommodation space 12 and the open growing space 13 were isolated from each other by the separation layer 40. That is, the sterile accommodation space 12 and the open growing space 13 did not communicate with each other anymore. Therefore, the medium layer 20 would not be contaminated by the exterior environment and the plant 30 would have the open growing space 13 communicating with the exterior environment. Furthermore, the layer of jelly wax used in the embodiment had flowability at room temperature, so the growth of the plant 30 would not be hindered by the separation layer 40.

In conclusion, according to the open plant cultivation device and the method for preparing the open plant cultivation device, the plant can live in the open growing space. Therefore, the problems in the closed plant cultivation device are overcome and the plant can be viewed, touched, or smelled. Due to the medium layer, the cultivator does not have to fertilize and cultivate the plant. Owing to the medium layer not communicating with the exterior, the possibility of the medium layer being contaminated by the exterior environment is decreased. Besides, the plant can be transplanted without acclimation after fully absorbing the medium layer.

What is claimed is:

1. An open plant cultivation device comprising:
a container having
an inner side surface;
a sterile accommodation space defined by the inner side surface; and
an open growing space defined by the inner side surface;
a medium layer disposed in the sterile accommodation space of the container;
a plant disposed in the sterile accommodation space and in the open growing space of the container; a part of the plant immersed in the medium layer; and
a separation layer disposed on the medium layer; the separation layer adjacent to the inner side surface of the container; the sterile accommodation space and the open growing space are isolated from each other by the separation layer.

2. The open plant cultivation device as claimed in claim 1, wherein a curing temperature of a material of the separation layer is from 20° C. to 70° C.

3. The open plant cultivation device as claimed in claim 1, wherein a thickness of the separation layer is from 0.05 cm to 5 cm.

4. The open plant cultivation device as claimed in claim 2, wherein a thickness of the separation layer is from 0.05 cm to 5 cm.

5. The open plant cultivation device as claimed in claim 1, wherein a material of the separation layer is natural wax, synthetic wax, lipid compound, or silicone-containing compound.

6. The open plant cultivation device as claimed in claim 1, wherein a material of the separation layer is polyester or polyepoxide.

7. The open plant cultivation device as claimed in claim 1, wherein the separation layer is formed in a solid, colloidal, or liquid state.

8. The open plant cultivation device as claimed in claim 2, wherein the separation layer is formed in a solid, colloidal, or liquid state.

9. The open plant cultivation device as claimed in claim 1, wherein a material of the medium layer includes water, an inorganic salt, an organic compound, or agar.

10. A method for preparing an open plant cultivation device, comprising steps of:
putting a container in a sterile space;
feeding a medium colloid into the container and immersing a part of a plant in the medium colloid;
solidifying the medium colloid into a medium layer; and
disposing a separation layer onto the medium layer to form the open plant cultivation device.

11. The method for preparing the open plant cultivation device as claimed in claim 10, wherein a curing temperature of a material of the separation layer is from 20° C. to 70° C.

12. The method for preparing the open plant cultivation device as claimed in claim 10, wherein a thickness of the separation layer is from 0.05 cm to 5 cm.

13. The method for preparing the open plant cultivation device as claimed in claim 10, wherein the method comprises feeding the medium colloid into the container before immersing the part of the plant in the medium colloid.

14. The method for preparing the open plant cultivation device as claimed in claim 10, wherein the method comprises disposing the plant in the container before feeding the medium colloid into the container and immersing the part of the plant in the medium colloid.

15. The method for preparing the open plant cultivation device as claimed in claim 10, wherein the medium layer is formed in a liquid, solid, or colloidal state.

16. The method for preparing the open plant cultivation device as claimed in claim 10, wherein the separation layer is formed in a liquid, solid, or colloidal state.

17. The method for preparing the open plant cultivation device as claimed in claim 10, wherein the method comprises solidifying the separation layer after disposing the separation layer.

18. The method for preparing the open plant cultivation device as claimed in claim 10, wherein a material of the medium layer includes water, an inorganic salt, an organic compound, or agar.

19. The method for preparing the open plant cultivation device as claimed in claim 18, wherein elements of the inorganic salt include carbon, hydrogen, oxygen, nitrogen, phosphorus, potassium, sodium, magnesium, calcium, sulfur, chlorine, ferric, boron, manganese, zinc, molybdenum, cobalt, copper, or iodine.

20. The method for preparing the open plant cultivation device as claimed in claim 18, wherein the organic compound includes carbohydrate, vitamin, inositol, adenine, or amino acid.
